(19) United States
(12) Patent Application Publication
(10) Pub. No.: US 2025/0290525 A1
(43) Pub. Date: Sep. 18, 2025

(54) Cooling fan

(71) Applicant: Brose Fahrzeugteile SE & Co. Kommanditgesellschaft, Würzburg, Würzburg (DE)

(72) Inventors: Hengjun Wang, Taicang (CN); Gao Jian, Shanghai (CN); Yaoliang Gao, Shanghai (CN)

(73) Assignee: Brose Fahrzeugteile SE & Co. Kommanditgesellschaft, Würzburg (DE)

(21) Appl. No.: 19/085,720

(22) Filed: Mar. 20, 2025

(30) Foreign Application Priority Data
Mar. 14, 2024 (DE) 102024107338.1
Mar. 20, 2024 (CN) 202410317728.0

(51) Int. Cl. F04D 29/70; B23K 20/10; F04D 19/00; F04D 29/32; F04D 29/64

(52) U.S. Cl. CPC F04D 29/703; B23K 20/10; F04D 19/002; F04D 29/329; F04D 29/644

(57) ABSTRACT

A cooling fan including a sand prevention cover covering a hub of the cooling fan, a connection structure comprising at least one positioning section for positioning the sand prevention cover to the hub and at least one fixing section for fixing the sand prevention cover to the hub, and the connection structure being formed as part of the sand prevention cover and as part of the hub.

### CROSS-REFERENCE TO RELATED APPLICATIONS

This application claims priority to German Application No. DE 102024107338.1 filed Mar. 14, 2024 and Chinese Application No. 202410317728.0 filed Mar. 20, 2024, the entire disclosures of which are incorporated by reference herein.

### TECHNICAL FIELD

The present invention relates to a cooling fan, in particular for a vehicle.

### BACKGROUND

Considering the architecture of a vehicle, cooling fans are used in an area of a motor cooling and/or an air-conditioning compressor, for example. In relation to a coordinate system of the vehicle, the rotation plane of the fan may be in particular oriented towards a vehicles head.

For example, DE 10 2015 106070 A1 describes an axial fan for a cooling fan module has a cup-shaped central hub with a front wall intended to be connected to the rotor of an electric motor at connection points and with a side wall from which a plurality of outer blades extend.

When driving in sandy environments, such as deserts, lots of sand may be gathered in the inner side of a hub of the cooling fan.

Common hub structures may not consider any issue of sand prevention. Disadvantageously, this may cause a bad unbalance of the cooling fan. In particular, the cooling fan with an out-of-standard balance value may cause in higher continuously vibrations which may be uncomfortable for a customer. Furthermore, structural damage of the cooling fan may occur.

### SUMMARY

In view of the above, an object of the present disclosure is to provide a new and improved cooling fan in which an unbalance value of the cooling fan is reduced also in sandy environment to a certain range to achieve fewer vibration and acoustics, for example, if the cooling fan is working at a high-speed rotation.

According to an aspect of the disclosure, a cooling fan comprises a sand prevention cover covering a hub of the cooling fan, a connection structure comprising at least one positioning section for positioning the sand prevention cover to the hub and at least one fixing section for fixing the sand prevention cover to the hub, and the connection structure may be formed as part of the sand prevention cover and as part of the hub.

Thus, one idea of the present disclosure is to implement a sand prevention cover to the hub of the cooling fan to guide the sand in the area of the hub. Further, the sand prevention cover may prevent the sand from entering the hub for better balancing while the vehicle is driving in a sandy environment, such as a desert or the like.

In other words, the disclosure provides a fan assembly comprising a cooling fan and a sand prevention cover. The sand prevention cover may be fixedly connected and/or joined on the hub and may prevent sand to flow into the hub for better balancing of the cooling fan. The assembly may be provided by interference fitting, transition fitting, clearance fitting or the like. Furthermore, connecting and/or joining the cooling fan and the sand prevention cover may be further ensured by ultrasonic welding, hot melt welding, hook locking, adhesive bonding, or the like.

The positioning section is formed as part of the sand prevention cover and as part of the hub. The positioning section may be provided as part of a ring segment of the sand prevention cover and as part of a ring segment of the hub.

The fixing section is formed as part of the sand prevention cover and as part of the hub. Also, the fixing section may be provided as part of a ring segment of the sand prevention cover and as part of a ring segment of the hub.

For example, an outer ring segment and/or an inner ring segment may be used for positioning, fixing and joining. Furthermore, there may be structures on the outer ring and inner ring for positioning, fixing and/or joining.

The sand prevention cover may have a ring shape to cover a ring segment of the hub.

The presently described sand prevention cover may further include a number of slopes to obtain the sand sliding out of the hub. The slopes may be formed as ribs protruding in a radial direction of the cooling fan.

Advantageous embodiments and improvements of the present disclosure are provided herein.

According to an embodiment of the disclosure, the at least one positioning section and/or the at least one fixing section may be formed at an outer ring segment and/or at an inner ring segment of the hub. An edge of the outer ring segment and/or the inner ring segment of the sand prevention cover and/or of the hub may be provided with some structures for positioning and fixing, e.g. at least one rib and/or at least one groove. Advantageously, the quantity and fitting dimensions may be adapted to requirements of stress conditions, structural conditions and/or assembly conditions.

According to an embodiment of the disclosure, one positioning section and/or one fixing section may be formed continuously along the inner or the outer ring segment. According to an embodiment, one rib may be formed at a ring segment, in particular at an edge of the ring segment, of the hub and/or the sand prevention cover. Thus, at least one corresponding groove may be formed at a ring segment, in particular at an edge of a ring segment of the cover and/or of the hub. In other words, a circumferential groove and/or a circumferential rib may be formed as connection structure.

According to an embodiment of the disclosure, the outer ring segment and the inner ring segment may be arranged on different radial positions of the hub. At least one ring segments may be provided as a ring protruding in axial direction of the hub.

According to an embodiment of the disclosure, the sand prevention cover may cover an area between the outer ring segment and the inner ring segment. Thus, the inner space of the hub may be prevented of sand. The inner ring segment and or the outer ring segment may have a height range from 0 mm to the same height as the height of the hub.

As an example, the positioning section and/or the fixing section may comprise radial and/or axial corresponding contact surfaces at the hub and at the sand prevention cover.

The contact surfaces or contact areas may be provided at axial contact surfaces having at least one groove and at least one corresponding protrusion oriented in axial direction of the cooling fan. This enables different design options dependent on the available space and the stress conditions.

According to an embodiment of the disclosure, the at least one fixing section and/or at least one positioning section may comprise at least one tongue and groove joint or tongue and groove connection. A welding groove may be arranged in the ring segment provided with at least one tongue. This welding groove may be a joining structure for ultrasonic welding or the same. To improve the sand prevention and fixing between the outer or inner ring segment and the hub, a hot melt welding structure may be provided on a fitting surface of the outer or inner ring segment. According to an embodiment, a further welding structure may be provided on the fitting surface and fill a remaining gap between the hub and the sand prevention cover.

According to an embodiment of the disclosure, the tongue and groove joint or tongue and groove connection may comprise at least one tongue protruding in an axial direction of the cooling fan. In one embodiment, a number of tongues may be provided, wherein the number of tongues may be spaced from each other in a circumferential direction of the hub. Thus, a number of corresponding grooves may be provided to contact the tongues when positioning and/or fitting the sand prevention cover to the hub.

According to an embodiment of the disclosure, the at least one fixing section may comprise at least one weld seam, in particular manufactured by using ultrasonic welding or hot melt welding. The meld seam may be provided at a fitting line at the connection section. Further, interference fitting, transition fitting or clearance fitting may be provided to close any remaining slit between the hub and the sand prevention cover.

According to an embodiment of the disclosure, the at least one fixing section may comprise at least one adhesive layer to fix the sand prevention cover to the hub by at least one adhesive bonding. This may also prevent from sand and may fit the hub to the sand prevention cover.

According to an embodiment of the disclosure, the at least one fixing section may comprise at least one undercut to fix the sand prevention cover to the hub by at least one hook locking. For example, a number of hooks may be provided at the circumference direction of the sand prevention cover, e. g. at an outer or inner ring segment of the sand prevention cover. Thus, each hook may protrude through a corresponding slit in the hub to lock the cover to the hub at the connection structure by hook locking. According to an embodiment, heads of the hooks may be melted by hot melt welding to provide material filled in the gap between the hook and the slit for optimize joining and sealing. This joining structure may be more simplified as the hook may be used for positioning the cover to the hub and hot melt welding may be used afterwards to seal the cover to the hub.

According to an embodiment of the disclosure, the at least one positioning section may comprise a number of grooves and/or protrusions for aligning the sand prevention cover in a circumferential position relative to the hub. The number of grooves and/or protrusions may be provided at ribs of the hub and/or at ribs of the sand prevention cover.

According to a further embodiment, the at least one positioning section may comprise at least one protrusion and at least one seating to support the sand prevention cover in a radial position relative to the hub. For example, the seating may be a part of an outer ring segment of the hub, and the protrusion may be a part of an outer edge of the sand prevention cover.

According to an embodiment of the disclosure, the at least one positioning section and the at least one fixing section may be arranged on different axial positions regarding to an axial direction of the cooling fan. This may be achieved by two ring segments with a different height, for example.

According to an embodiment of the disclosure, the protection cover may comprise an inclined surface between the at least one positioning section and the at least one fixing section. The inclined surface may be inclined towards a hub axis. In particular, the inclined surface may be angled from 0 degrees to 80 degrees with respect to the hub axis. Such a surface may be configured to let sand slide out of the hub more easily.

According to an embodiment of the disclosure, the protection cover may comprise a number of radial ribs between the at least one positioning section and the at least one fixing section. The ribs may improve the stability of the sand prevention cover. Furthermore, the ribs may provide a cooling function for cooling the motor in the cooling fan module.

### BRIEF SUMMARY OF THE DRAWINGS

The present disclosure is explained in more detail below with reference to the embodiments shown in the schematic figures:

FIG. 1 depicts an isometric view of a cooling fan according to an embodiment of the disclosure.

FIG. 2 depicts another isometric view of a cooling fan according to an embodiment of the disclosure.

FIG. 3 depicts a view of a hub with and without a sand prevention cover according to further embodiment of the disclosure.

FIG. 4 depicts a view of a sand prevention cover.

FIG. 5 depicts a cross-sectional view of a hub with a sand prevention cover.

FIG. 6 depicts a cross-sectional view of a hub and a cross-sectional view of a sand prevention cover according to FIG. 5.

FIG. 7 depicts further cross-sectional views of connection structures according to the disclosure.

FIG. 8 depicts further cross-sectional views of a connection interface according to another embodiment of the disclosure.

FIG. 9 depicts a view of a hub with and without a sand prevention cover according to a further embodiment of the disclosure.

FIG. 10 depicts a view of a sand prevention cover according to a further embodiment of the disclosure.

FIG. 11 depicts a cross-sectional view of a hub with a sand prevention cover according to a further embodiment of the disclosure.

FIG. 12 depicts a cross-sectional view of a hub and a cross-sectional view of a sand prevention cover according to FIG. 11.

FIG. 13 depicts a cross-sectional view according to the embodiment of FIG. 12.

FIG. 14 depicts cross-sectional views according to the embodiment of FIG. 12.

FIG. 15 depicts a cross-sectional view of a positioning section according to another embodiment.

FIG. 16 depicts cross-sectional views according to the embodiment of FIG. 15.

FIG. 17 depicts further cross-sectional views of connection structures according to the disclosure.

FIG. 18 depicts further cross-sectional views of a connection interface according to another embodiment of the disclosure.

FIG. 19 depicts a view of a hub with and without a sand prevention cover according to a further embodiment of the disclosure.

FIG. 20 depicts a view of a sand prevention cover according to a further embodiment of the disclosure.

FIG. 21 depicts a cross-sectional view of a hub with a sand prevention cover according to a further embodiment of the disclosure.

FIG. 22 depicts a cross-sectional view of a hub and a cross-sectional view of a sand prevention cover according to FIG. 21.

FIG. 23 depicts a cross-sectional view according to the embodiment of FIG. 22.

FIG. 24 depicts cross-sectional views according to the embodiment of FIG. 22.

In the figures of the drawing, elements, features and components which are identical, functionally identical and of identical action are denoted in each case by the same reference designations unless stated otherwise.

Although specific embodiments are illustrated and described herein, it will be appreciated by those of ordinary skill in the art that a variety of alternate and/or equivalent implementations may be substituted for the specific embodiments shown and de-scribed without departing from the scope of the present invention. Generally, this application is intended to cover any adaptations or variations of the specific embodiments discussed herein.

### DETAILED DESCRIPTION OF EMBODIMENTS

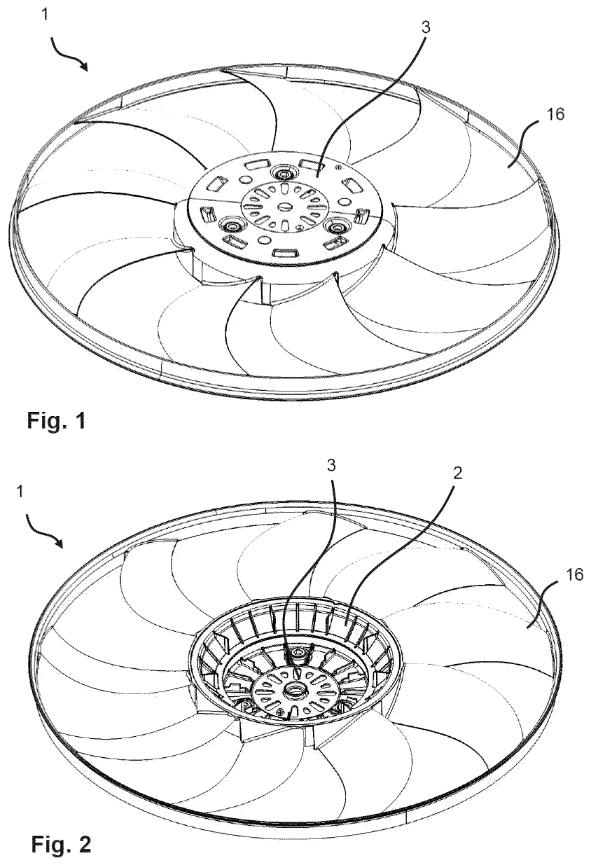

FIGS. 1 and 2 show an isometric view of a cooling fan 1 according to an embodiment of the invention. When driving in sandy environments, such as deserts, lots of sand may be gathered in the inner side of a hub 3 of the cooling fan 1.

Common hub structures may not consider any issue of sand prevention. Disadvantageously, this may cause a bad unbalance of the cooling fan 1. Furthermore, structural damage of the cooling fan 1 may occur. Thus, a sand prevention cover 2 is provided to cover the hub 3. Consequently, the “free spaces” between the ribs of the hub 3 may be sealed to prevent the hub 3 from sand accumulation.

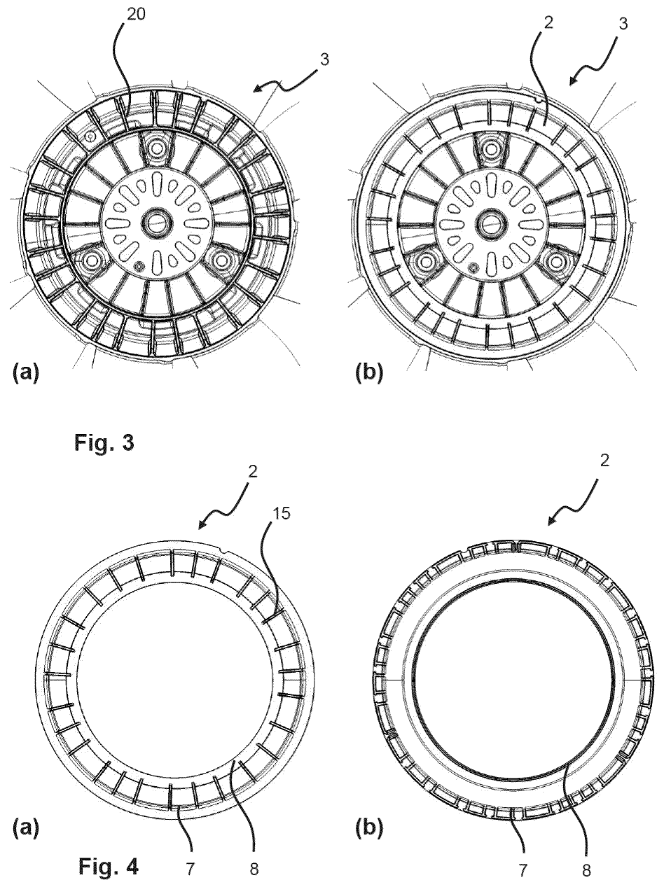

FIG. 3(b) shows a hub 3 having open spaces between the number of ribs 20, and FIG. 3(b) shows the hub 3 with the sand prevention cover 2 covering the spaces between the ribs 20.

Connection structures 4 are provided at the sand prevention cover 2 and at the hub 3 for positioning, fixing and joining.

The sand prevention cover 2 may be arranged as disclosed in FIG. 4. The sand prevention cover 2 may have a ring shape. In particular, the ring shape may be bordered by an outer ring segment 7 and an inner ring segment 8. FIG. 4 (a) shows the sand prevention cover 2 from a front side, and FIG. 4 (b) shows the sand prevention cover 2 from a rear side. Radial ribs 15 may be provided at the front or the rear side of the sand prevention cover 2.

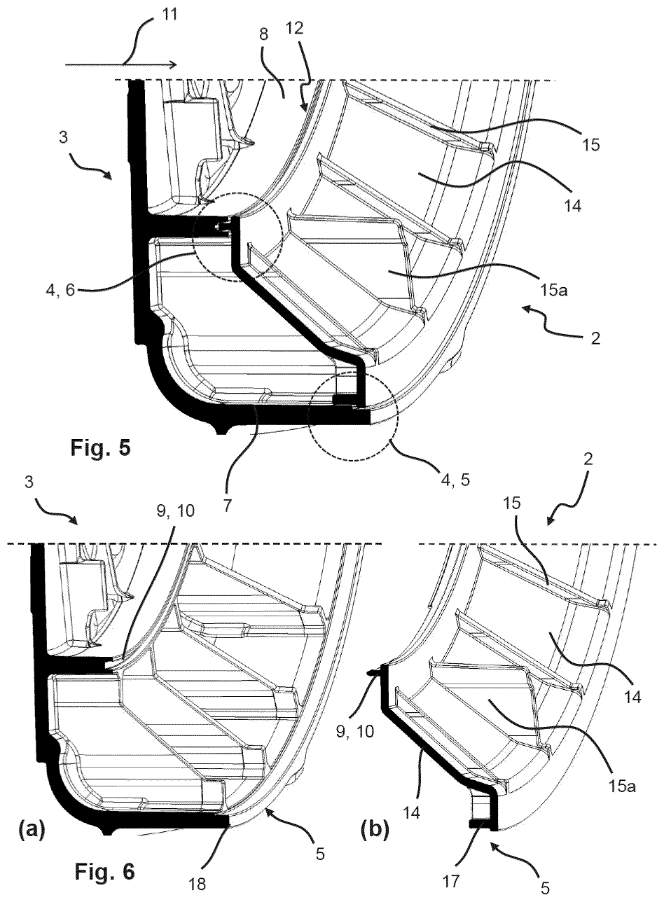

The sand prevention cover 2 may be fixedly joined or fixed on the hub 3 as shown in FIGS. 5, 6, 11, 12, 21 and 22 for example.

FIGS. 5 and 6 show a cross-sectional view of a hub 3 with a sand prevention cover 2. The outer ring segment 7 and the inner ring segment 8 may protrude in an axial direction 11 of the cooling fan 1. The ring segments 7, 8 may have different heights, so that the connection structures 4 may be provided at different positions in axial direction 11 and the sand prevention cover may be provided with an inclined surface 14. One connection structure 4 may be formed as positioning section 5, and the other connection structure 4 may be formed as fixing section 6.

A weld seam 12 may be provided to join the structures, wherein the weld seam 12 may be provided by ultrasonic welding or the same. The weld seam 12 may seal the fixing section 6. A weld seam 12 may also be provided at the positioning section 5 to seal the positioning section 5.

The fixing section 6 may have a tongue and groove joint 9. The tongue and groove joint 9 may be provide a welding groove to join the hub 3 and the cover 2 by ultrasonic welding, for example. The tongue and groove joint 9 may have at least one tongue 10 protruding in the axial direction 11. The tongue 10 may be formed at an edge of the inner ring segment 8. In other words, the connection structures 4 may form fitting structures.

In one embodiment, a number of tongues 10 may be provided, wherein the number of tongues 10 may be spaced from each other in a circumferential direction of the hub 3. Thus, a number of corresponding grooves may be provided to contact the tongues 10 when positioning and/or fitting the sand prevention cover 2 to the hub 3.

The positioning section 5 may have a protrusion 17 for contacting with a seating 18 at an outer ring segment 7.

The ring segments 7, 8 may have a height range from 0 mm to the same height as the height of the hub 3 in the axial direction 11.

The radial ribs 15, 15a may improve a structure stability of the sand prevention cover 2 and may provide air inside to cool down the motor in the cooling fan module.

As joining methods ultrasonic welding, hot melt welding, hook locking, adhesive bonding and so on can be used.

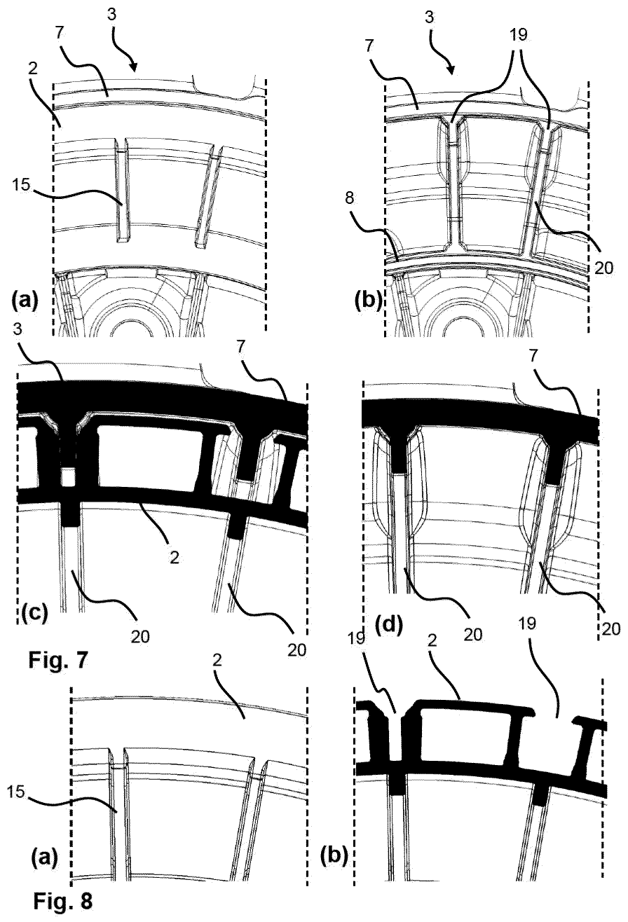

FIGS. 7 and 8 show further cross-sectional views in an axial direction of connection structure 4 according to the invention. According to an embodiment, the ribs 20 may be fixed to protrusions 19 of the outer ring segment 7.

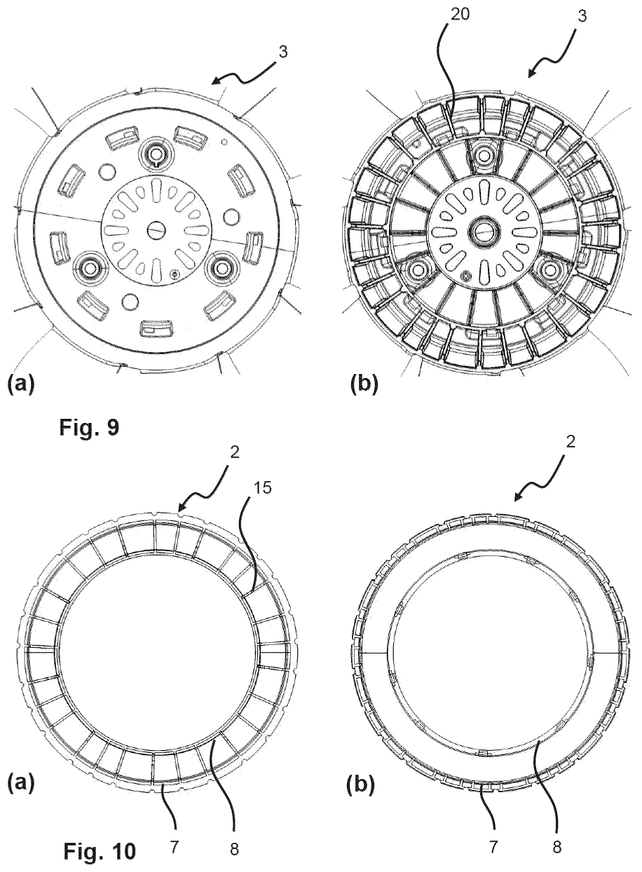

FIGS. 9 and 10 show views of a hub 3 with and without a sand prevention cover 2 according to a further embodiment of the invention.

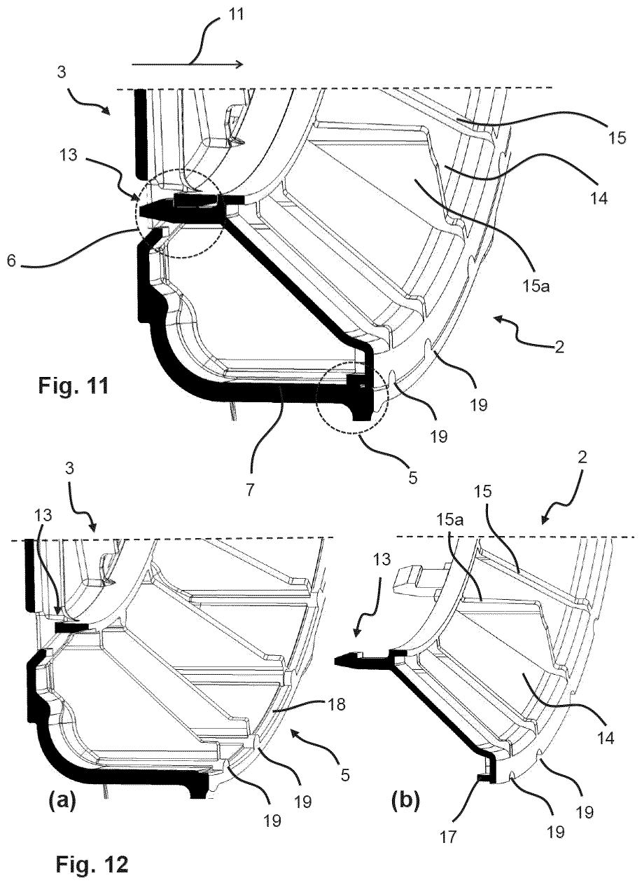

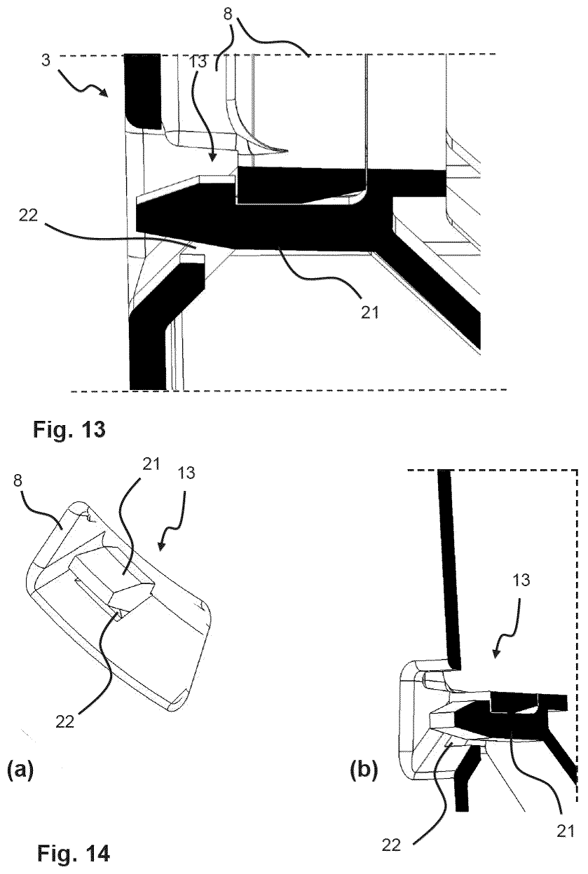

FIGS. 11 to 14 show a cross-sectional view of a hub 3 with a sand prevention cover 2 according to a further embodiment of the invention. At least one hook 21 may be provided at the sand prevention cover 2 to protrude through an opening 22 of the hub 3 to form a hook locking. An undercut 13 may be formed by the hook 21 and the opening 22 to fix the cover 2 to the hub 3.

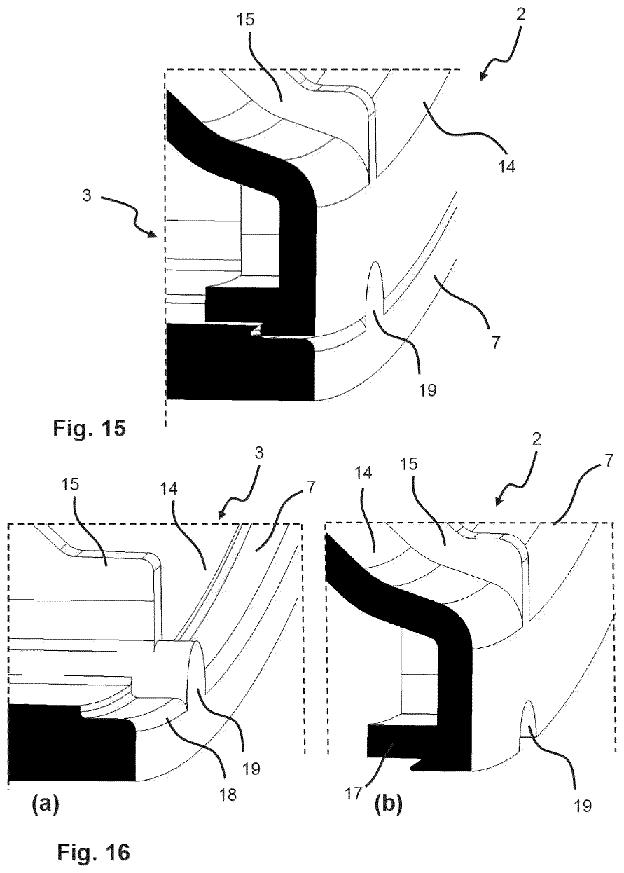

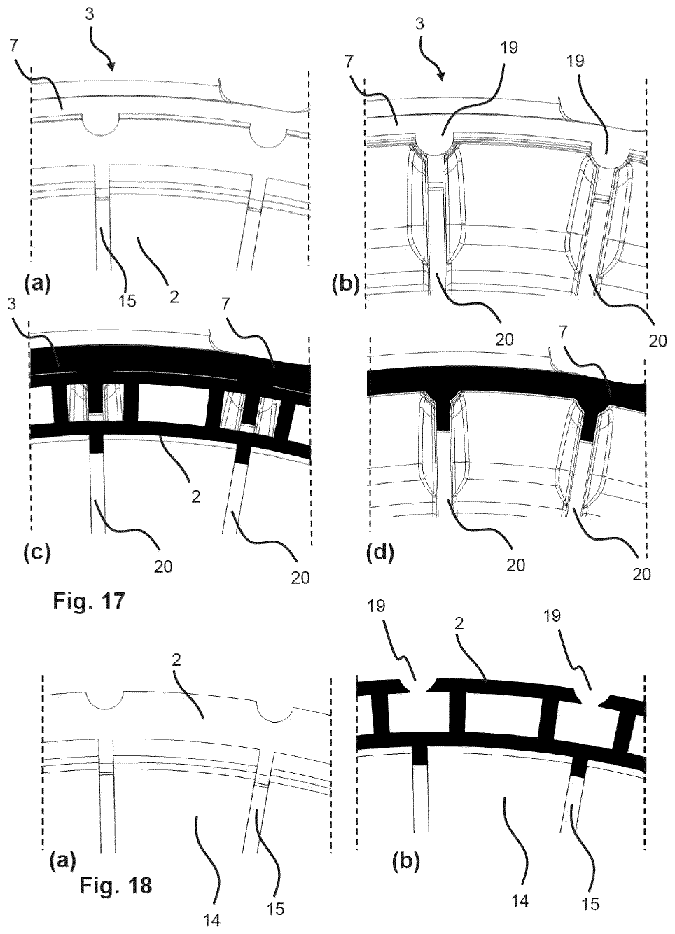

FIGS. 15 to 18 show a cross-sectional view of a positioning section 5 according to another embodiment. For better sand prevention and fixing between the outer ring segment 7 and hub 3, an ultrasonic welding structure may be provided on the seating 18 to provide a welding support. Further, protrusions 19 may be formed at different circumferential positions of the hub 3 and/or the sand prevention cover 2 to positioning the cover 2 to the hub 3 in a desired circumferential position. The weld seam may fill a gap between the protrusions 19 and the seating 18.

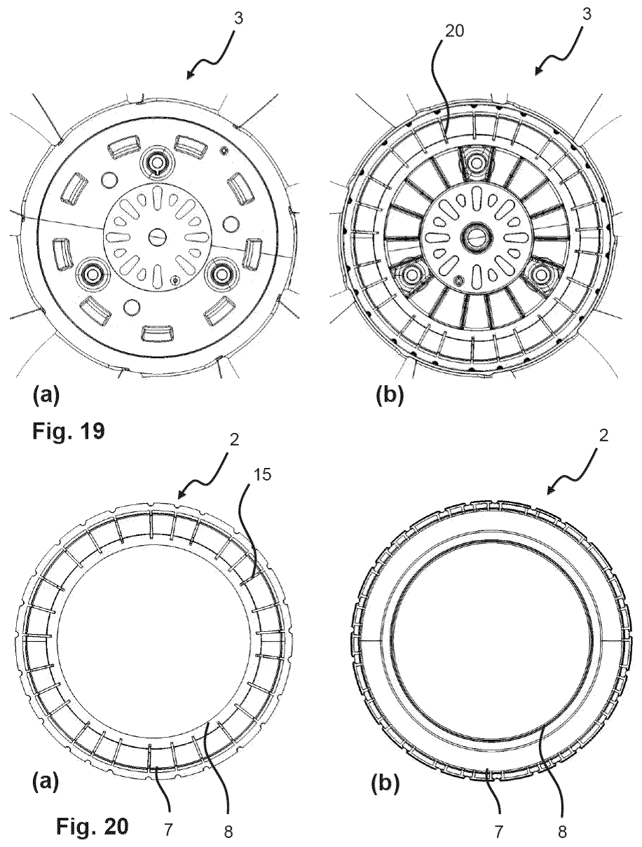

FIGS. 19 and 20 shows a view of a hub 3 with and without a sand prevention cover 2 according to a further embodiment of the invention.

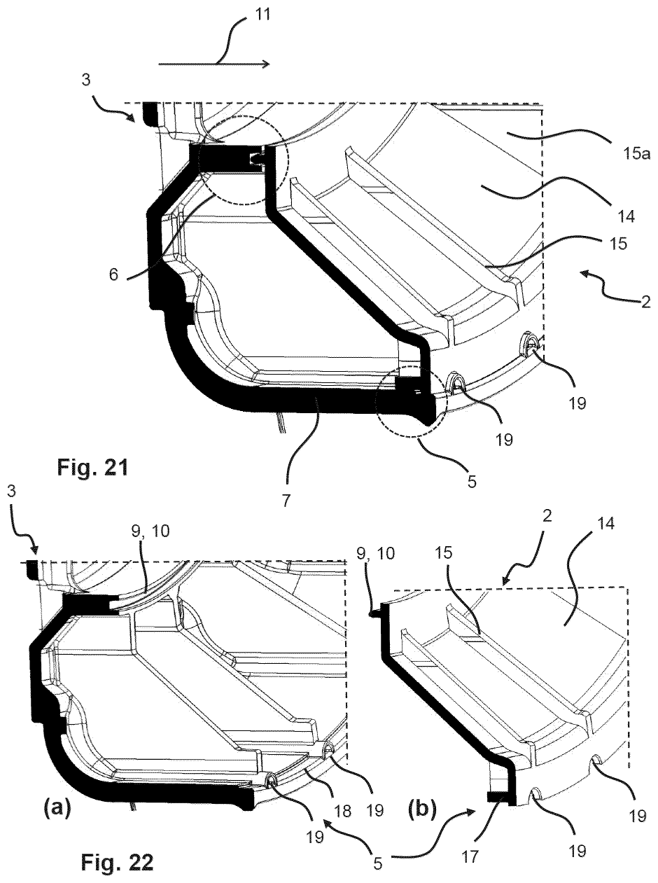

FIGS. 21 and 22 show connection structures 4 according to a further embodiment of the invention. The fixing section 6 may be sealed by interference fitting, transition fitting or clearance fitting to prevent from sand. The fixing section 6 may be formed as a tongue and groove joint 9.

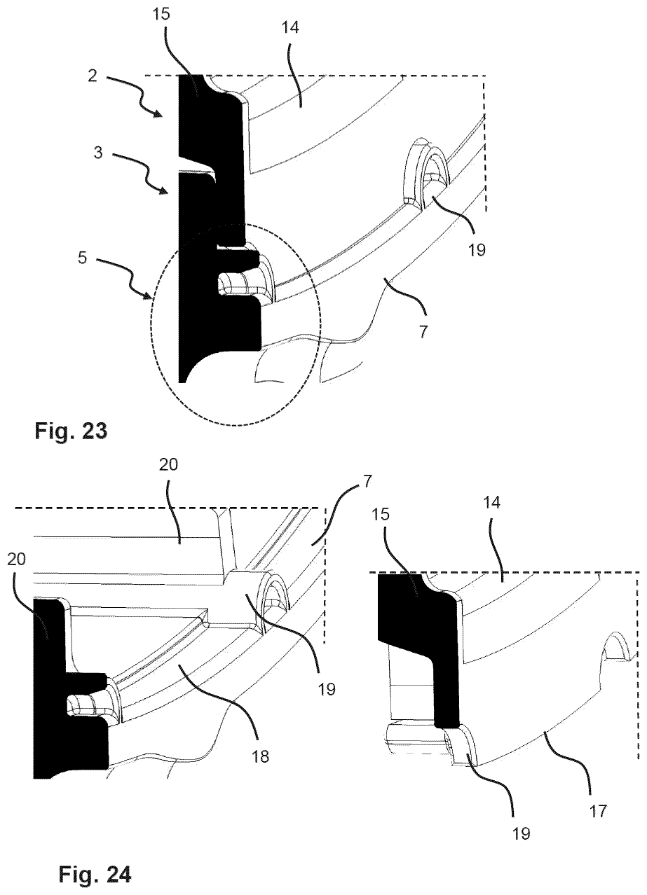

FIGS. 23 and 24 show a cross-sectional view according to the embodiment of FIG. 22. For better sand prevention and fixing between the outer ring segment 7 and the sand prevention cover 2, a hot melt welding structure may be provided along the seating 18 and the protrusions 19. Thus, a gap between the hub 3 and the sand prevention cover 2 may be sealed.

In a further embodiment, which is not shown, the positioning section 5 as shown may be replaced by the fixing section 6 for providing a fixing section at an outer ring segment 7. Further, the fixing section 6 as shown may be replaced by the positioning section 5 for providing a positioning section at an inner ring segment 7.

Consequently, the invention provides a cooling fan 1, wherein the sand prevention cover 2 may be fixedly joined on the hub 3 to prevent sand flowing in a space between the hub 3 and the sand prevention cover 2. This allows better balancing while the vehicle driving in a desert. In addition, slopes, e. g. ribs 15, may be provided to achieve that the sand slide out of the hub 3.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification. The embodiments were chosen and described in order to best explain the principles of the invention and its practical applications, to thereby enable others skilled in the art to best utilize the invention and various embodiments with various modifications as are suited to the particular use contemplated.

### REFERENCE LIST

1 cooling fan
2 sand prevention cover
3 hub
4 connection structure
5 positioning section
6 fixing section
7 outer ring segment
8 inner ring segment
9 tongue and groove joint
10 tongue
11 axial direction
12 weld seam
13 undercut
14 inclined surface
15 radial ribs
16 fan
17 protrusion
18 seating
19 protrusion
20 ribs of the hub
21 hook
22 opening

1. A cooling fan, comprising:
a sand prevention cover covering a hub of the cooling fan;
a connection structure comprising at least one positioning section, for positioning the sand prevention cover with respect to the hub, and at least one fixing section for fixing the sand prevention cover to the hub,
wherein the connection structure is formed as part of the sand prevention cover and as part of the hub.

2. The cooling fan of claim 1, wherein the at least one positioning section and/or the at least one fixing section are formed at an outer ring segment and/or at an inner ring segment of the hub.

3. The cooling fan of claim 2, wherein one positioning section of the at least one positioning section and/or one fixing section of the at least one fixing section are formed continuously along the inner or the outer ring segment.

4. The cooling fan of claim 2, wherein the outer ring segment and the inner ring segment are each arranged on different radial positions of the hub.

5. The cooling fan of claim 2, wherein the sand prevention cover covers an area between the outer ring segment and the inner ring segment.

6. The cooling fan of claim 1, wherein the at least one fixing section and/or the at least one positioning section include at least one tongue and groove joint.

7. The cooling fan of claim 6, wherein the tongue and groove joint includes at least one tongue protruding in an axial direction of the cooling fan.

8. The cooling fan of claim 1, wherein the at least one fixing section includes at least one weld seam.

9. The cooling fan of claim 1, wherein the at least one fixing section includes at least one adhesive layer configured to fix the sand prevention cover to the hub by at least one adhesive bond.

10. The cooling fan of claim 1, wherein the at least one fixing section includes at least one undercut configured to fix the sand prevention cover to the hub by at least one locking hook.

11. The cooling fan of claim 1, wherein the at least one positioning section includes a number of grooves and/or protrusions collectively configured to align the sand prevention cover in a circumferential position relative to the hub.

12. The cooling fan of claim 1, wherein the at least one positioning section includes at least one protrusion and at least one seating collectively configured to support the sand prevention cover in a radial position relative to the hub.

13. The cooling fan of ONE claim 1, wherein the at least one positioning section and the at least one fixing section are arranged on different axial positions with respect to an axial direction of the cooling fan.

14. The cooling fan of claim 1, wherein the sand prevention cover includes an inclined surface extending between the at least one positioning section and the at least one fixing section.

15. The cooling fan of claim 1, wherein the sand prevention cover includes a number of radial ribs extending between the at least one positioning section and the at least one fixing section.

16. The cooling fan of claim 8, wherein the at least one weld seam is formed by ultrasonic welding or hot melt welding.

17. A cooling fan comprising:
a hub;
a plurality of blades extending from the hub;
a protection cover configured to cover the hub; and
a connection structure including at least one positioning section and at least one fixing section, the at least one positioning section configured to position the sand prevention cover with respect to the hub, and the at least one fixing section configured to fix the protection cover to the hub,
wherein the protection cover and the hub collectively form the connection structure.

18. The cooling fan of claim 17, wherein the protection cover is a sand prevention cover configured to prevent sand from entering the hub.

19. The cooling fan of claim 18, wherein the at least one positioning section includes a number of grooves and/or protrusions collectively configured to align the sand prevention cover in a circumferential position relative to the hub

20. The cooling fan of claim 17, wherein the at least one fixing section and/or the at least one positioning section include at least one tongue and groove joint.
